(19) United States
(12) Patent Application Publication
(10) Pub. No.: US 2024/0168471 A1
(43) Pub. Date: May 23, 2024

(54) INTEROPERABILITY PREDICTOR USING MACHINE LEARNING AND REPOSITORY OF TX, CHANNEL, AND RX MODELS FROM MULTIPLE VENDORS

(71) Applicant: Tektronix, Inc., Beaverton, OR (US)

(72) Inventors: Kan Tan, Portland, OR (US); John J. Pickerd, Hillsboro, OR (US); Sam J. Strickling, Cypress, TX (US)

(73) Assignee: Tektronix, Inc., Beaverton, OR (US)

(21) Appl. No.: 18/514,800

(22) Filed: Nov. 20, 2023

Related U.S. Application Data
(60) Provisional application No. 63/427,760, filed on Nov. 23, 2022.

(51) Int. Cl. G05B 23/02

(52) U.S. Cl. CPC G05B 23/0254; G05B 23/0216

(57) ABSTRACT

A test system includes a repository of component models containing characteristic parameters for each component model, one or more processors to receive a list of selected component models through a user interface to be tested as a combination, access the characteristic parameters for each selected component model, build a tensor image using the characteristic parameters, send the tensor image to one or more trained neural networks to predict interoperability of the combination, and receive a prediction about the combination. A method includes receiving a list of selected component models through a user interface to be tested as a combination, accessing characteristic parameters for the selected component models, building a tensor image for each combination of the selected component models, sending the tensor image to one or more trained neural networks to predict interoperability of the combination, and receiving a prediction about the combination.

### CROSS-REFERENCE TO RELATED APPLICATIONS

This disclosure claims benefit of U.S. Provisional Application No. 63/427,760, titled “INTEROPERABILITY PREDICTOR USING MACHINE LEARNING AND REPOSITORY OF TX, CHANNEL, AND RX MODELS FROM MULTIPLE VENDORS,” filed on Nov. 23, 2022, the disclosure of which is incorporated herein by reference in its entirety.

### TECHNICAL FIELD

This disclosure relates to test and measurement systems, and more particularly to a test and measurement system that employs machine learning.

### BACKGROUND

Organizations that receive components from many different vendors need to ensure that the components and end products pass compliance/safety/validation standards. Products that include a communication link have a particularly high need for compliance. As an example, optical transceivers need to meet these requirements, with the understanding that this represents just one example.

Currently, data center “Hyperscalers” receive transceivers from various vendors. A Master Test Requirements Document (MTRD) or standards documentation will show the yield and other characteristics of transceivers needed for them to pass. The Hyperscaler will perform an additional battery of tests to ensure that they are ready for production. However, despite all these tests Hyperscalers struggle to determine why in some cases transceivers that have passed rigorous testing still fail when connected to other transceivers that have also passed standards testing. This problem becomes exacerbated when Hyperscalers work with multiple suppliers on multiple product families. It is not uncommon for a Hyperscaler to have 4-5 suppliers for 2-3 product families with multiple revisions of the product in use at any one time.

When bad links are formed, they can have serious ramifications. The link failures lead to internet downtime, degraded network performance, and lack of customer trust. Troubleshooting the location of the issue costs both time and resources for Hyperscalers who are constantly looking for ways to improve performance while reducing cost.

### BRIEF DESCRIPTION OF THE DRAWINGS

FIG. 1 shows an embodiment of a test and measurement instrument.

FIGS. 2 and 3 shows examples of user interfaces for an interoperability application.

FIGS. 4-8 show block diagrams of different testing configurations.

FIG. 9 shows an embodiment of a training configuration for an interoperability prediction system.

FIG. 10 shows an embodiment of a runtime configuration for an interoperability prediction system.

### DESCRIPTION

This disclosure describes a novel system using machine learning and a model repository containing receivers (Rx), transmitters (Tx), and channel models from many different vendors. Embodiments of the disclosure generally allow a user to select a list of models they wish to simulate for electrical/optical path interoperability, and then run thru potentially thousands of simulated combinations, in a very short processing time assisted by a trained neural network that receives the model data as input and predicts pass or fail and the link operation margin. The link operation margin is the value that assesses the operation margin of the link. Embodiments of the disclosure perform this interoperability prediction potentially thousands of times faster than could be done using existing test instrumentation, and/or existing system simulation tools. Further advantages of embodiments of the disclosure are that it requires no expensive and complex test equipment setups since embodiments may be implemented in software only, and that embodiments provide a hardware agnostic system.

One must note that the use of electrical or optical transmitters, receivers and the hardware that constitutes the channel represents one example of the overall use of this interoperability system. This system applies to many other types of systems assembled from multiple components that would benefit from interoperability predictions. No limitation to the particular components here is intended, nor should any be implied.

Embodiments of the disclosure address this need by providing unique opportunities for insight into how to avoid link failures and improve interoperability.

The discussion below uses an example embodiment of the disclosure implemented as a software application called OptaML™ InterOp. One objective of OptaML InterOp is to obtain a library of TX, RX, and channel models from vendors and engineers. Then allow the user to create a list of component models to test for interoperability, and then sweep thru all combinations of the models in the list and provide a report on the results. This greatly speeds up the process and moves it from a realm of unfeasibility for the user to a realm of feasibility at low cost and fast results.

U.S. patent application Ser. No. 17/747,954, titled “SHORT PATTERN WAVEFORM DATABASE BASED MACHINE LEARNING FOR MEASUREMENT,” filed May 18, 2022, hereinafter “the '954 application,” describes the use of a tensor image, constructed from a database of short pattern waveforms, as input to a machine learning system. The contents of the '954 application are hereby incorporated by reference into this disclosure.

U.S. patent application Ser. No. 17/877,829, filed Jul. 29, 2022, titled “COMBINED TDECQ MEASUREMENT AND TRANSMITTER TUNING USING MACHINE LEARNING,” hereinafter “the '829 application,” the contents of which are hereby incorporated by reference into this disclosure in their entirety, describes a test system that employs a machine learning component, which can used for predicting optimal tuning parameters for a device under test (DUT), such as an optical transceiver or transmitter, for example. The test system described in the '829 application may also employ a machine learning component for predicting a performance measurement or attribute of the DUT, such as a TDECQ measurement, for example. Both sets of predictions are assisted with trained deep learning neural networks. The test system described in the '829 application may include a tensor image builder to construct a tensor image, such as the tensor image described in the '954 application as input to the deep learning networks.

U.S. patent application Ser. No. 18/199,846, filed May 19, 2023, titled “AUTOMATED CAVITY FILTER TUNING USING MACHINE LEARNING,” hereinafter “the '846 application,” describes test systems and methods that use a machine learning component for automated cavity filter tuning. The machine learning component takes as input a tensor image built from measured S-parameters of a device under test. U.S. patent application Ser. No. 18/510,234, filed Nov. 15, 2023, titled “METHODS FOR 3D TENSOR BUILDER FOR INPUT TO MACHINE LEARNING,” hereinafter “the '234 application,” describes an improved tensor builder than that described in the '846 application which allows more efficient use of the tensor image space for better predictions from the machine learning component. The entire contents of these applications are hereby incorporated by reference into this disclosure.

U.S. patent application Ser. No. 17/951,064, filed Sep. 22, 2022, titled “SYSTEM AND METHOD FOR DEVELOPING MACHINE LEARNING MODELS FOR TESTING AND MEASUREMENT,” hereinafter “the '064 application,” the contents of which are hereby incorporated by reference into this disclosure in their entirety, describes systems and methods for developing machine learning models for testing and measurement of electronic devices.

Embodiments of the disclosure build off the training and runtime machine learning environments described in the applications above, to implement new test systems and methods for greatly speeding up the interoperability tests of transmitters, channels, and receivers.

Embodiments of the disclosure generally pass pre known S-parameter models plus other measured parameters that characterize the Tx, the Rx and the channel into the neural net and directly predict a pass or fail and a link operation margin label for a given set of models for transmitter, channel, and receiver, as discussed in more detail below. Embodiments of the disclosure dramatically reduce the simulation execution time required for thousands of combinations of these models.

Traditionally a major focal point of interoperability testing is performed at plug fests which are conducted, for example, by UNH, University of New Hampshire. This is where the university sponsors neutral test station setups, and vendors bring in their devices to test interoperability with other vendor components. In this environment, the interoperability has different areas of focus, such as protocol and signal connection compatibilities, and electrical characteristics. The process is expensive, and time consuming. This traditional process does not readily support thousands of combinations of interactions.

Embodiments of the disclosure focus on the electrical and optical characteristics of the transmitter, the channel, and the receiver connections. S-parameter models and other measured parameters of these items may be provided by vendors into an OptaML item library. Customer vendors may then select the items from the library that they want to simulate for interoperability. The OptaML InterOp application will then sequence through all combinations of the models in the list and provide a pass/fail and link operation margin report.

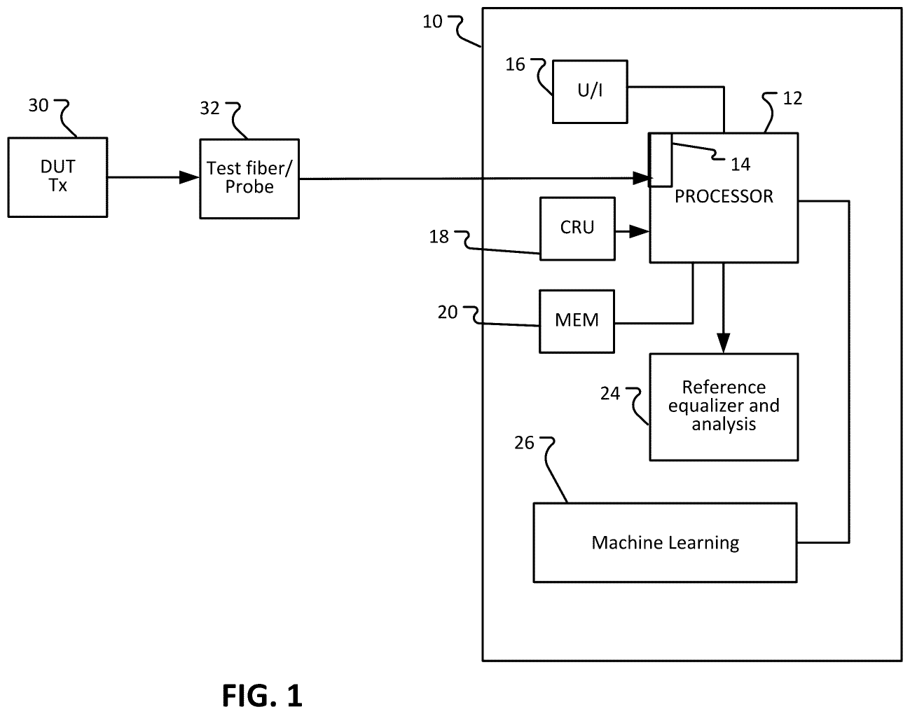

The embodiments may involve a test station that includes the processing capacity to perform the tasks. The test station may comprise a computing device, and the computing device may take the form of a test and measurement instrument having one or more processors executing code that causes the processors to perform the various tasks. FIG. 1 shows an embodiment of a testing setup in the instance of an optical transmitter 30 as a device under test (DUT). The testing setup includes a test and measurement system that may include a test and measurement instrument such as an oscilloscope 10. The test and measurement instrument 10 receives a signal from the DUT 30 through an instrument probe 32. The probe will typically comprise a test fiber to send a signal to the test and measurement instrument through one or more ports 14, typically electrical but the signal could also be optical. Two ports may be used for differential signaling, while one port is used for single channel signaling. The signals are sampled and digitized by the instrument to become waveforms. A clock recovery unit (CRU) 18 may recover the clock signal from the data signal if the test and measurement instrument 10 comprises a sampling oscilloscope for example. A software clock recovery can be used on a real-time oscilloscope.

The test and measurement instrument has one or more processors represented by processor 12, a memory 20 and a user interface 16. The memory may store executable instructions in the form of code that, when executed by the processor, causes the processor to perform tasks. User interface 16 of the test and measurement instrument allows a user to interact with the instrument 10, such as to input settings, configure tests, etc. The test and measurement instrument may also include a reference equalizer and analysis module 24.

The embodiments here employ machine learning in the form of a machine learning network 26, such a deep learning network. The machine learning network may include a processor that has been programmed with the machine learning network as either part of the test and measurement instrument, or to which the test and measurement instrument has access through a connection. As test equipment capabilities and processors evolve, one or more processors such as 12 may include both.

As will be discussed in more detail below, the computing device is connected to a repository of component models. The term “component model” as used here means the particular model provided by a particular manufacturer of the component being tested. For example, the model repository may contain information about many different models of transmitters, receivers, and channels. As used there, the term “channel” refers to any component that connects a transmitter with a receiver. While the channels here will typically comprise physical links, such as cables with varying lengths and connectors, no limitations exist to physical links. One could extend the concepts of the embodiments to wireless channels. The repository allows a user to combine different models of components and then determine if they can operate together successfully.

Tektronix, Inc. offers a software application known as Serial Data Link Analysis (SDLA) (see https://www.tek.com/en/solutions/application/serial-data-link-analysis-sdla), which can receive the S-parameter models and combine their characteristics of how a given transmitter, and channel, and receiver would affect a waveform. The resulting simulated waveform may then be measured and analyzed by Tektronix's PAMJET (see https://www.tek.com/en/datasheet/pam4-transmitter-analysis) and/or DPOJET (see https://www.tek.com/en/datasheet/jitter-noise-and-eye-diagram-analysis-solution) analysis software applications to determine margin and pass/fail status of the given combination of models.

The SDLA, PAMJET, and DPOJET applications take significant amounts of time to calculate their respective simulations and measurements. For example, if it took them 2 minutes per combination for 10,000 combinations of models, it would take around 2 months of execution time to perform the interoperability simulation.

In contrast, feeding the models'S-parameters and measured parameters to a neural net that can predict pass fail and link operation margin in 1 second, according to embodiments of the disclosure, then that time would take 2.6 hours to simulate. This represents a speed up factor of 120×, as just simulation time speedup. If the test used real test equipment for this test, it would comprise a very expensive test station plus it would need the ability to collect, configure and measure the 10,000 combinations of DUTs. One could estimate that this would be thousands of times slower, and not practical to implement.

One should note that while the below discussion uses the OptaML application running on a computing device, one could develop or use other applications.

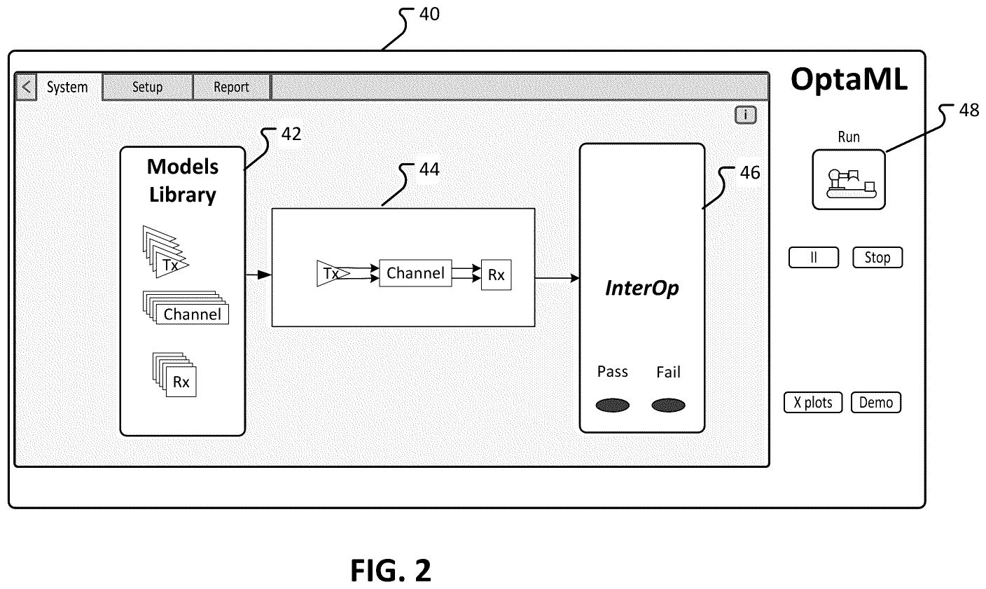

FIG. 2 shows an OptaML user interface from a customer's perspective. The customer would go to the Setup tab at the top of the interface to see a list of available component models in the library/repository in the model library interface 42. Prior to offering a component model as a selection, contributing vendors would have provided the information needed about those models prior to training the product for public release. The middle graphic 44 shows the selection of the combination to be tested. One should note that the combinations may or may not include all three of the components shown. Other combinations may involve just the transmitter and the channel, or just the receiver, etc. Regardless of how many components are to be tested, the discussion herein will refer to those as a “combination.” The user would then press the Run 48 button to start the sweeping and testing of all combinations of the transmitters, channel, and receivers or other combination in the list. The user may pause, continue, or stop the automated sweep at any time. When completed the system provides an interoperability report to the user, which may comprise the pass/fail indicator on the InterOp graphic 46.

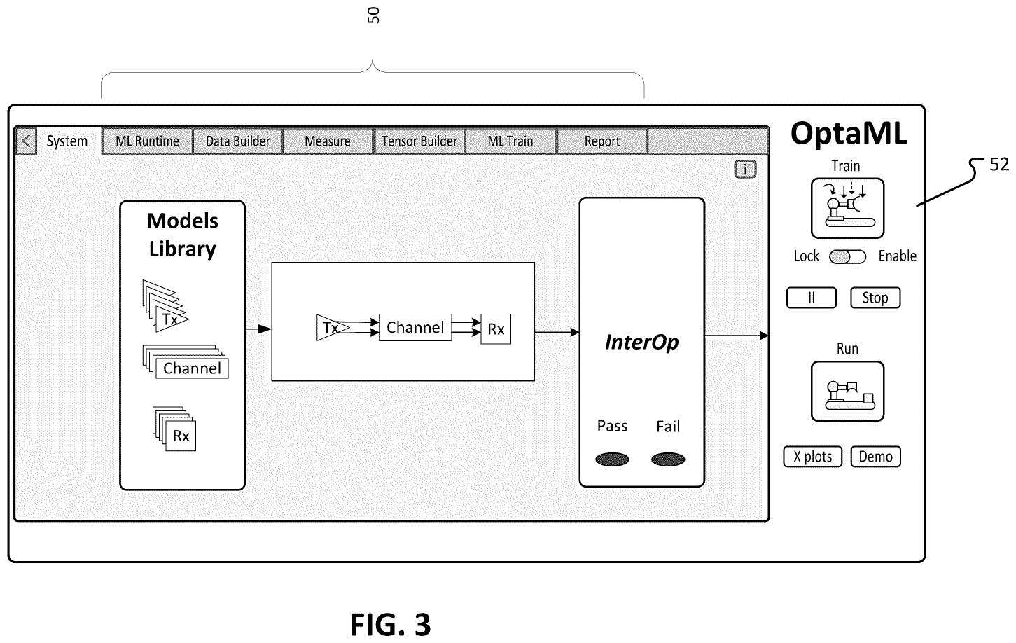

FIG. 3 shows a menu seen by the engineers, such as the OptaML engineers, who train the model prior to public release. This menu includes additional menu tabs 50 for setting up the data inputs for training, the tensor builder configuration, and the deep network hyperparameter settings. The engineer can control the states of the system using the pause, continue, Train, Run, and Stop states in the side panel menu 52.

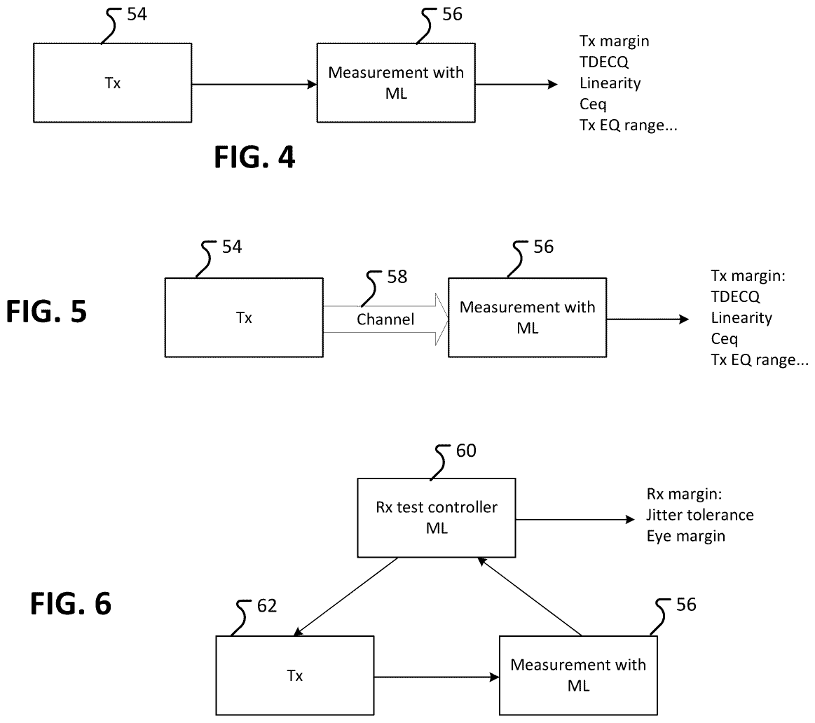

As mentioned above, the combination may comprise only the transmitter. FIGS. 4-7 show various combinations that may undergo testing. FIG. 4 shows a setup for only measuring the transmitter output, and the margin related parameters are obtained. Generally speaking, the transmitter 54 and its output may be fed into the scope and machine learning 56 may be used to speed up the measurements such as TDECQ (transmitter dispersion eye closure quadrature), linearity, CEQ, and determine the range taps setting, and the Tx EQ range. The transmitter model shall contain an S-parameter set to represent correct shaping of an ideal signal fed into it. These may be n-port S-parameters. Model data may also contain multiple characteristics parameters measured at the TX output such as TDECQ, linearity, CEQ, and Tx EQ range. Tx EQ range represents a range for each EQ tap that is to be allowed for tuning the transmitter and optimizing it with the given combination of transmitter, channel, and receiver models.

FIG. 5 shows a setup that adds channel model 58 after the transmitter 54. The channel will have loss, reflection, and crosstalk effects on the transmitter waveform. S-parameter sets commonly represent these effects as a function of frequency. This would consist of a collection of channel models represented by S-parameter data. The library will include a wide range of channels with different loss, cross coupling, and characteristic impedance. The setup measures the signal at the end of the channel and the margin related parameters are obtained.

FIG. 6 shows a configuration representing testing of a receiver 60. A calibrated signal source 62 such as a BERT drives the receiver, and the various measurements are made at 56 to determine quality. This diagram shows potential for using machine learning as part of the test configuration for observing receiver output and predicting calibrated source settings. The setup obtains the margin related receiver measurements such as jitter tolerance and the eye margin, and an S-parameter set.

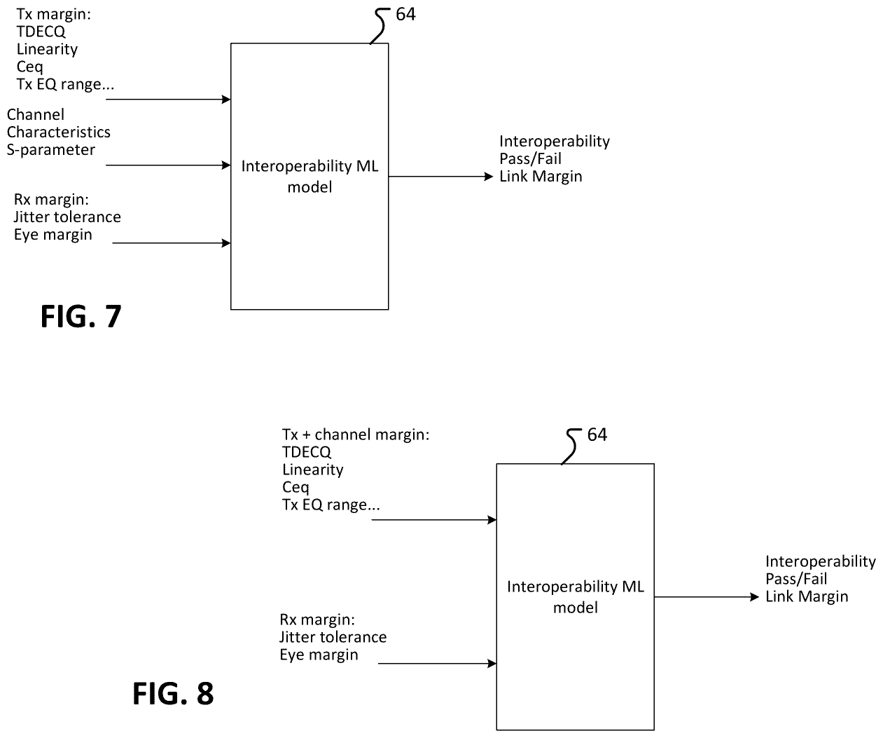

FIG. 7 shows a view of a foundational block of embodiments of the disclosure. According to embodiments, a trained neural network configuration 64 receives inputs of model data for a transmitter, a channel, and a receiver, and then outputs an interoperability pass/fail indicator, link operation margin and/or other information. One should note that the machine learning system could perform this analysis on multiple combinations, where the user could select multiple transmitters, channels, and receivers. This would allow the user to pick the best combination based upon values obtained from the trained neural network(s). One should note that the term “model” as applied to the machine learning model does not mean the same as the component models.

FIG. 8 shows an alternative block diagram that only includes measured model parameters for the transmitter plus channel and the receiver. In FIG. 7, the (Tx+Channel)+Rx are represented. The (Tx+Channel) input sits top left. In FIG. 6, Tx and Channel are separate inputs. Both FIG. 6 and FIG. 7 consider the full link: Tx, Channel, Rx. This demonstrates that the system can work with whatever data is available for some components.

The interoperability systems according to embodiments of the disclosure first creates a model repository of component models and data from many different vendors representing their transmitters and receivers. In addition, the embodiments create a library of S-parameters for various types of channels the transmitter and receiver must communicate through. While the user will not perform any neural network training, the embodiments include the training of the neural network that can receive as input a Tx model, a channel model, a receiver RX model and then predict pass or fail and link operation margin for that combination of interoperability. The link operation margin comprises a measurement value that typically provides an indication of whether or not the link will work.

If the customer had such a model repository available, they could use tools like Tektronix SDLA (Serial Link Data Analysis), Ansoft Designer or other simulation tools to analyze different combinations of different vendors' transmitters and channels and receivers. Currently, they likely do not have such a library of models. Even with the library, as discussed above, it would be very time consuming for them to manually go into those tools and process all combinations of channels and Tx and Rx.

Therefore, a benefit of this prediction system is that it would have a model repository with a user interface that allows the user to select a list of transmitters and channels and different vendor receiver models and then obtain a fast output result of all combinations in the list. Then obtain pass fail and link operation margin results report.

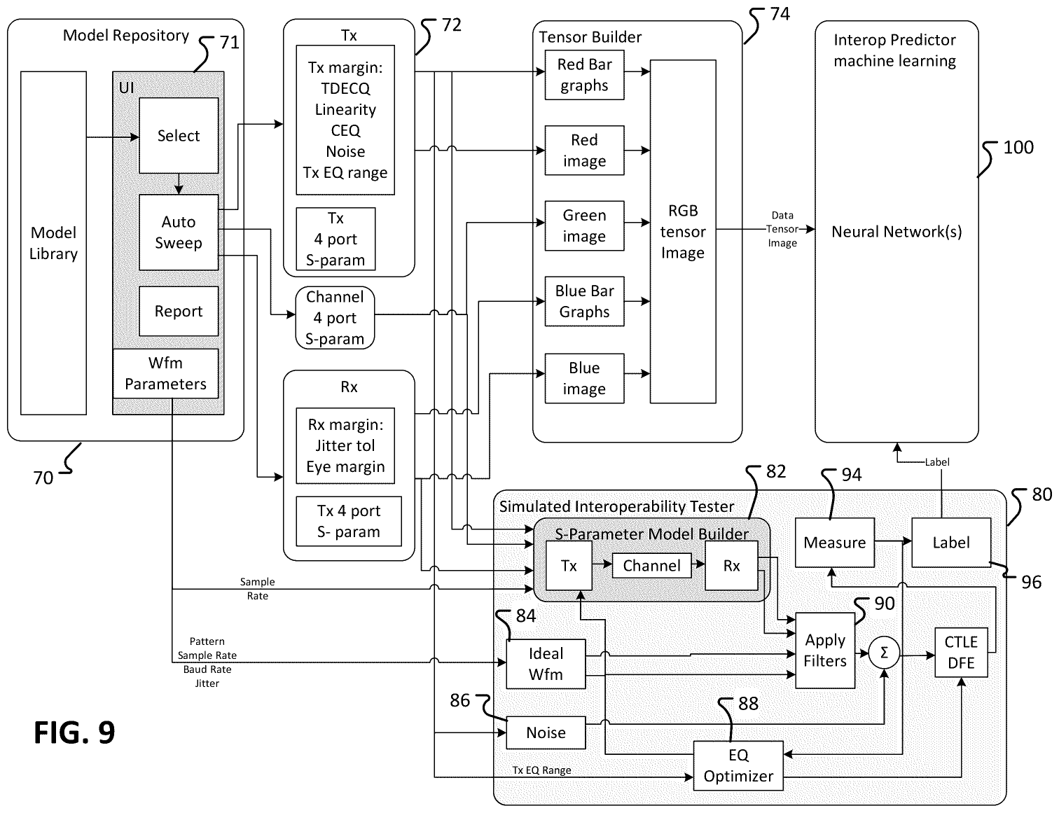

The discussion turns now to FIG. 9, showing an embodiment of the OptaML InterOp system configured for training prior to shipping it to customers. For training purposes, the menu represented in FIG. 2 has the features needed for training. Those features would only be seen by the OptaML engineers who perform the training of the neural networks model and not be seen by the customers who use the application.

Prior to training, one must go out to multiple vendors and obtain S-parameter characteristics for their transmitters and receivers' electrical paths. The embodiments also create the model library for multiple channels with different attenuation, crosstalk, and impedance characteristics. Vendors may also provide channel models, and standards committees may also define channels that should be used in testing. The main UI control 71 and automated sweep would then sweep through all combinations of the transmitters, channels, and receivers during the training process.

UI control 71 allows the user to select a list of models. The user may select a list of transmitters, channels, and receivers for which they want to predict interoperability. The automated sweep control allows the user to initiate the sweep to apply all combinations of the selected models into the trained neural network to obtain pass/fail prediction for each combination. The report generator provides a report of the pass/fail and link operation margin results for all combinations.

The system presents each model combination to both a tensor builder block 74 and to the simulated interoperability tester block 80. The tensor builder places the models into an RGB tensor image to be used as input to the deep learning network for training and for runtime prediction after training is completed. In the embodiment shown in FIG. 8, the transmitter margin parameters make up the red channel bar graphs, and the transmitter S-parameters make up the red channel image. One should note that while the embodiments show 4-port S-parameters, they could use any n-number port S-parameters. The channel information makes up the green channel image. The blue channel bar graph comprises the receiver margin parameters, and the blue channel image comprises the receiver S-parameters. The tensor builder block 74 builds the tensor image and provides it to the neural network(s) 100. One should note that for combinations that do not use all the available components, the tensor image will only include the channels that have data.

The simulated interoperability tester block 80 receives the S-parameter models at the S-parameter model builder, which may comprise a tool such as Tektronix's SDLA tool mentioned above. The UI control 71 also provides general waveform parameters to the Simulated Interoperability Tester block 80, which generates ideal waveforms based on the models. The S-parameter model builder will produce filters. The block applies these filters and noise that typically comes from the transmitter characteristics to the ideal waveforms to produce simulated waveforms. This block convolves the model filters from SDLA with the ideal waveforms from the generator. For example, for differential waveform representation, filter 1 is convolved with the positive leg waveform of the differential channel and filter 2 is convolved with the negative leg waveform of the differential channel and the two resulting waveforms are added together to create one waveform. This waveform is then measured to determine pass/fail and link operation margin.

In one embodiment the S-parameter model builder may comprise Tektronix SDLA for S-parameter modeling filter generation. It may also be some other type of S-parameter modeling software. The three S-parameter blocks are configured into a system model and the filters representing the output of the system when an ideal signal is applied to the input, are created. This block primarily operates during the training of the neural network to create labels. Runtime prediction does not need it for prediction of pass/fail by the classification network. However, runtime fail predictions may use it to validate the prediction.

PAMJET, DPOJET, or other similar types of applications will measure simulated waveforms. The system then generates a label as pass or fail, and other labels such as link operation margin. The system then uses these labels as the metadata input to the deep learning network during the training process. The deep learning network training allows it to associate a given input model tensor image with a given label such as pass or fail and link operation margin. In some embodiments, multiple deep learning networks may be used. For example, a classification network may be used to get a pass/fail result, while a regression model may be used to get a margin value.

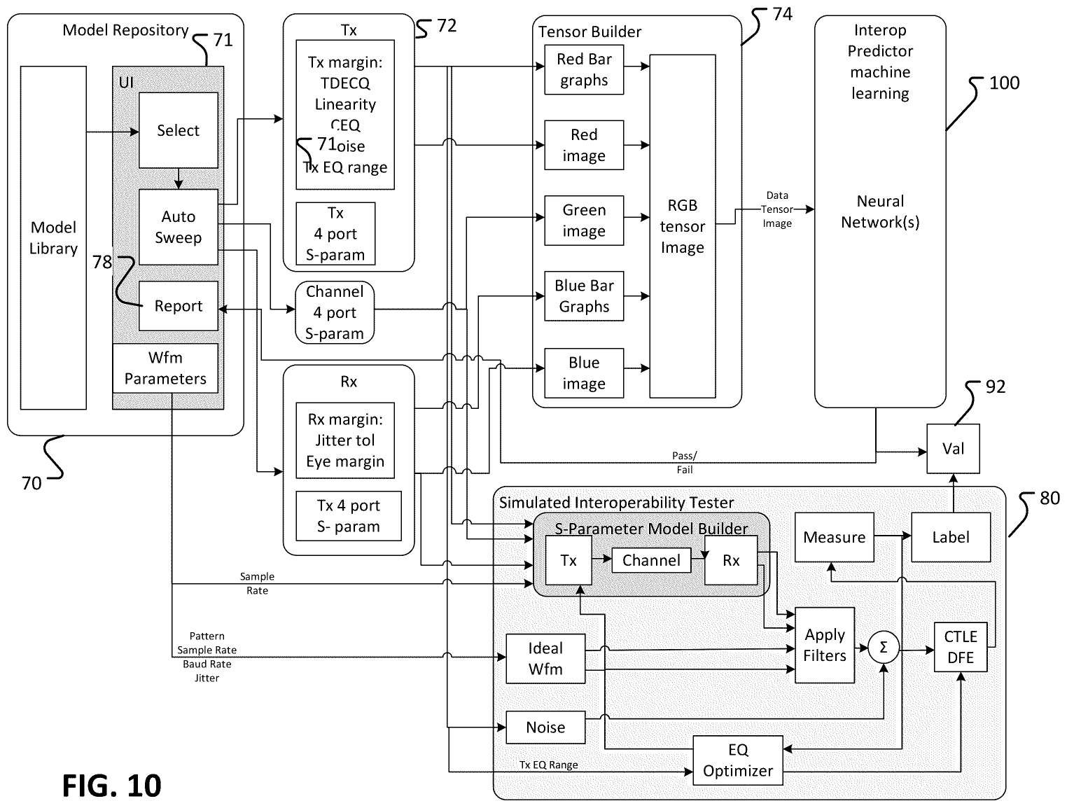

FIG. 10 shows the detailed block diagram for runtime sweeps and pass/fail predictions. The trained neural network allows customers to use it to predict pass/fail of the interoperability and link operation margin of multiple vendor models. The user would go to the model library, some of which was used for training, and select a list of models they wish to test for interoperability. The library would keep growing as new models are added. The trained neural network then operates to predict on the new models, discussed below, and old models. The customer would push the Run button as shown in FIG. 2. The automation sweep block would then go through the list and create all combinations of the models in the list to obtain a pass-fail and link operation margin prediction for each combination.

One should note that the embodiments do not use the Simulated Interoperability Tester 80 to obtain this prediction. The models of whichever or all the transmitter, channel, and receiver are input to the tensor builder to create an RGB image using the same algorithms as were used during the training process. This tensor builder 74 feeds this image to the neural network(s) 100, which produces an output of the network of Pass/Fail, and link operation margin labels. The output may only comprise the Pass/Fail output. This report generator 78 in the user interface block of the Model Repository 70 receives the label to generate a report.

If the report generator receives a Fail label, then the UI controller may opt to send the model to the Simulated Interoperability Tester to verify or validate that the combination truly failed at 92. The result of that validation may be used to update the training of the neural network.

The model library may contain component models that are added after training, typically new component models a user wants to try. These may or may not work with the trained neural network(s). If they fail, then the simulated tester may provide validation. The testing may still achieve faster results by some of them working with the ML prediction, and with the Simulated Interoperability Tester working for a smaller percentage of the combinations.

After some period of collecting component models upon which the neural networks have not trained, OptaML developers may run thru a new training cycle to include those new component model additions, and then release a new version of the application that supports the new models.

The embodiments include the possibilities of performing. Measurements using physical test equipment can replace the simulation that yields the labels such as pass, fail, and link operation margin. The resulting labels form these actual measurements can be used for training and validation.

In this manner, the embodiments provide a system and method to allow for interoperability testing for multiple models of multiple components. The neural networks can provide pass/fail indications and link margin measurements in a fraction of the time a traditional system would take to measure one combination.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test system, comprising: a repository of component models containing characteristic parameters for each component model; one or more processors configured to execute code to cause the one or more processors to: receive a list of selected component models through a user interface to be tested as a combination; access the characteristic parameters for each selected component model in the list; build a tensor image using the characteristic parameters for each selected component model; send the tensor image to one or more trained neural networks to predict interoperability of the combination; and receive a prediction from the one or trained neural networks about the combination.

Example 2 is the test system of Example 1, wherein the one or more neural networks comprise two neural networks, a first neural network to provide a pass/fail prediction, and a second neural network to provide a prediction of an operational margin.

Example 3 is the test system of either of Examples 1 or 2, wherein the code that causes the one or more processors to access the characteristic parameters for each selected component comprises code to cause the one or more processors to either access the characteristic parameters from the repository or access physical testing results.

Example 4 is the test system of any of Examples 1 through 3, wherein the combination comprises one of a transmitter, a transmitter with a channel, a receiver with a transmitter, a receiver with a channel and a transmitter together, and a transmitter with a channel and with a receiver.

Example 5 is the test system of any of Examples 1 through 4, wherein the one or more processors are further configured to provide a report of the predictions received for each combination.

Example 6 is the test system of any of Examples 1 through 5, wherein the one or more processors are further configured to validate the predictions for those combinations for which the prediction is that the combination failed.

Example 7 is the test system of any of Examples 1 through 6, wherein the one or more processors are further configured to train the neural networks.

Example 8 is the test system of Example 7, wherein the one or more processors are further configured to train the one or more neural networks by executing code that causes the one or more processors to: generate combinations from the component models in the repository; build tensor images for each combination; generate ideal waveforms of each combination; apply filters and any noise to the ideal waveforms to produce simulated waveforms; make one or more measurements on the simulated waveforms to produce measurement results; and provide the measurement results and tensor images for each combination to the one or more neural networks to train the one or more neural networks to associate each tensor image with a corresponding measurement result.

Example 9 is the test system of Example 8, wherein the code that causes the one or more processors to apply filters and noise to the ideal waveforms causes the one or more processors, for each combination, to: build an S-parameter model filter from S-parameters for the combination; and combine the S-parameter model filter for the combination with the ideal waveforms for the combination, and with any noise for the combination to produce the simulated waveform for the combination.

Example 10 is the test system of Example 8, wherein the noise results from a transmitter component model, such that combinations not including a transmitter will have no added noise.

Example 11 is the test system of Example 8, wherein the code that causes the one or more processors to make one or more measurements comprises code that causes the one or more processors to perform a pass/fail determination.

Example 12 is the test system of Example 8, wherein the code that causes the one or more processors to make one or more measurements comprises code to cause the one or more processors to perform an operational margin measurement.

Example 13 is a method, comprising: receiving a list of selected component models through a user interface to be tested as a combination; accessing characteristic parameters for the selected component models; building a tensor image using the characteristic parameters for each combination of the selected component models in the list; sending the tensor image to one or more trained neural networks to predict interoperability of the combination; and receiving a prediction from the one or more trained neural networks about the combination.

Example 14 is the method of Example 13, wherein sending the tensor image to one or more trained neural networks comprises sending the tensor image to two neural networks, a first neural network to provide a pass/fail prediction, and a second neural network to provide a prediction of an operational margin.

Example 15 is the method of either of Examples 13 or 14, wherein the accessing the characteristic parameters for each selected component comprises one of either accessing the characteristic parameters from a repository of characteristic parameters or accessing physical testing results.

Example 16 is the method of any of Examples 13 through 15, further comprising providing a report of the predictions received for each combination.

Example 17 is the method of Example 16, further comprising validating the predictions for those combinations for which the prediction is that the combination failed.

Example 18 is the method of any of Examples 13 through 17, further comprising training the one or more neural networks.

Example 19 is the method of Example 18, wherein training the one or more neural networks comprises: generating combinations from the component models in the component repository; building tensor images for each combination; generating ideal waveforms of each combination; applying filters and any noise to the ideal waveforms to produce simulated waveforms; making one or more measurements on the simulated waveforms to produce measurement results; and providing the measurement results and tensor images for each combination to the one or more neural networks to train the one or more neural networks to associate each tensor image with a corresponding measurement result.

Example 20 is the method of Example 19, wherein applying filters and noise comprises: building an S-parameter model filter from S-parameters for the combination; and combining the S-parameter model filter for the combination with the ideal waveforms for the combination and any noise for the combination to produce the simulated waveform for the combination.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

1. A test system, comprising:
a repository of component models containing characteristic parameters for each component model;
one or more processors configured to execute code to cause the one or more processors to:
receive a list of selected component models through a user interface to be tested as a combination;
access the characteristic parameters for each selected component model in the list;
build a tensor image using the characteristic parameters for each selected component model;
send the tensor image to one or more trained neural networks to predict interoperability of the combination; and
receive a prediction from the one or trained neural networks about the combination.

2. The test system as claimed in claim 1, wherein the one or more neural networks comprise two neural networks, a first neural network to provide a pass/fail prediction, and a second neural network to provide a prediction of an operational margin.

3. The test system as claimed in claim 1, wherein the code that causes the one or more processors to access the characteristic parameters for each selected component comprises code to cause the one or more processors to either access the characteristic parameters from the repository or access physical testing results.

4. The test system as claimed in claim 1, wherein the combination comprises one of a transmitter, a transmitter with a channel, a receiver with a transmitter, a receiver with a channel and a transmitter together, and a transmitter with a channel and with a receiver.

5. The test system as claimed in claim 1, wherein the one or more processors are further configured to provide a report of the predictions received for each combination.

6. The test system as claimed in claim 1, wherein the one or more processors are further configured to validate the predictions for those combinations for which the prediction is that the combination failed.

7. The test system as claimed in claim 1, wherein the one or more processors are further configured to train the neural networks.

8. The test system as claimed in claim 7, wherein the one or more processors are further configured to train the one or more neural networks by executing code that causes the one or more processors to:
generate combinations from the component models in the repository;
build tensor images for each combination;
generate ideal waveforms of each combination;
apply filters and any noise to the ideal waveforms to produce simulated waveforms;
make one or more measurements on the simulated waveforms to produce measurement results; and
provide the measurement results and tensor images for each combination to the one or more neural networks to train the one or more neural networks to associate each tensor image with a corresponding measurement result.

9. The test system as claimed in claim 8, wherein the code that causes the one or more processors to apply filters and noise to the ideal waveforms causes the one or more processors, for each combination, to:
build an S-parameter model filter from S-parameters for the combination; and
combine the S-parameter model filter for the combination with the ideal waveforms for the combination, and with any noise for the combination to produce the simulated waveform for the combination.

10. The test system as claimed in claim 8, wherein the noise results from a transmitter component model, such that combinations not including a transmitter will have no added noise.

11. The test system as claimed in claim 8, wherein the code that causes the one or more processors to make one or more measurements comprises code that causes the one or more processors to perform a pass/fail determination.

12. The test system as claimed in claim 8, wherein the code that causes the one or more processors to make one or more measurements comprises code to cause the one or more processors to perform an operational margin measurement.

13. A method, comprising:
receiving a list of selected component models through a user interface to be tested as a combination;
accessing characteristic parameters for the selected component models;
building a tensor image using the characteristic parameters for each combination of the selected component models in the list;
sending the tensor image to one or more trained neural networks to predict interoperability of the combination; and
receiving a prediction from the one or more trained neural networks about the combination.

14. The method as claimed in claim 13, wherein sending the tensor image to one or more trained neural networks comprises sending the tensor image to two neural networks, a first neural network to provide a pass/fail prediction, and a second neural network to provide a prediction of an operational margin.

15. The method as claimed in claim 13, wherein the accessing the characteristic parameters for each selected component comprises one of either accessing the characteristic parameters from a repository of characteristic parameters or accessing physical testing results.

16. The method as claimed in claim 13, further comprising providing a report of the predictions received for each combination.

17. The method as claimed in claim 16, further comprising validating the predictions for those combinations for which the prediction is that the combination failed.

18. The method as claimed in claim 13, further comprising training the one or more neural networks.

19. The method as claimed in claim 18, wherein training the one or more neural networks comprises:
generating combinations from the component models in the component repository;
building tensor images for each combination;
generating ideal waveforms of each combination;
applying filters and any noise to the ideal waveforms to produce simulated waveforms;
making one or more measurements on the simulated waveforms to produce measurement results; and
providing the measurement results and tensor images for each combination to the one or more neural networks to train the one or more neural networks to associate each tensor image with a corresponding measurement result.

20. The method as claimed in claim 19, wherein applying filters and noise comprises:
building an S-parameter model filter from S-parameters for the combination; and
combining the S-parameter model filter for the combination with the ideal waveforms for the combination and any noise for the combination to produce the simulated waveform for the combination.
